(19) United States
(12) Patent Application Publication
(10) Pub. No.: US 2007/0003719 A1
(43) Pub. Date: Jan. 4, 2007

(54) Food sachets

(75) Inventor: Ian Henry Balchin, Oxfordshire (GB)

Correspondence Address: LAW OFFICES OF WILLIAM H. HOLT, 12311 HARBOR DRIVE, WOODBRIDGE, VA, 22192, US

(73) Assignee: STANELCO RF TECHNOLOGIES LTD, Marchwood Industrial Park (GB)

(21) Appl. No.: 10/571,320

(22) PCT Filed: Sep. 2, 2004
(86) PCT No.: PCT/GB04/03732

§ 371 Date: Apr. 21, 2006

(30) Foreign Application Priority Data
Sep. 9, 2003 (GB) 0320997.0

(51) Int. Cl. B32B 27/32

(52) U.S. Cl. 428/35.2

(57) ABSTRACT

Sachets are made from at least one thin and flexible film (10, 18) of a water-soluble and edible polymeric material, the film and/or films being shaped to define a sachet and filled with a food material (16), and being sealed to form a peripheral seal by RF welding between opposed electrodes (12, 20). The film may be of starch. The sachet and contents are added to water, without needing to be cut open, before being eaten or drunk, or cooked. For example the food material might be coffee powder or dried soup, or a mixture for making bread; the film dissolves readily and is substantially tasteless. RF welding provides reliable seals despite any powder on the surfaces of the film.

This invention relates to a process for making sachets, particularly but not exclusively sachets containing food material, and also to the resulting sachets.

Starch is a widely used food ingredient. Transparent films made of starch, typically combined with a plasticiser, are now available commercially, for example those developed by Adept Polymers Ltd, Manchester, United Kingdom. Such films may for example be made from thermoplastically processable starch as described in U.S. Pat. No. 5,362,777 or U.S. Pat. No. 5,280,055.

According to the present invention there is provided a process for making sachets, the process using at least one thin and flexible film of a water-soluble and edible polymeric material, the film or films being shaped to define a sachet and filled with a food material, and being sealed to form a flange seal by RF welding between opposed electrodes.

In a second aspect the invention provides a process for making sachets, the process using at least one thin and flexible film comprising starch, the film or films being shaped to define a sachet, and being sealed to form a flange seal by RF welding between opposed electrodes.

The food material is one which is intended to be added to water, possibly with other ingredients, before being eaten or drunk. For example the food material might be coffee powder or dried soup, or spices, sugar, or a mixture for making bread or a cake, or dried foods such as noodles or fried rice. The food material might also comprise non-aqueous liquids such as olive oil. The sachet is envisaged as being of size between a few milliliters and about a liter, and is primarily intended for domestic use. If the film is of starch that is not water-soluble, then the contents may contain water. In a further alternative the sachets may contain only air, for example for use as bubble-wrap packaging material.

Such a sachet of food can be added to water or other ingredients without being opened, as the sachet itself will dissolve in the aqueous phase leaving no trace. The material of which the sachet is made is substantially tasteless, and in any event is a very small proportion of the total mass because the film is thin. The film preferably comprises starch, possibly with a plasticiser, as this is an inexpensive raw material; it also has the benefit of a very low oxygen permeability. Although in principle other edible polymers may be used or combined with starch to form such a film, this tends to increase the cost significantly. The polymeric material must not contain any harmful or toxic additives, but may contain compounds such as glycerol (E422) or glycerol monostearate (E471) as plasticisers, these compounds also being ingestible and dispersible or soluble in water. Previously known methods for bonding edible polymeric materials do not provide a seal of sufficiently reliable quality, particularly in situations where dusty material is likely to be deposited on the area where the seal is required.

To perform dielectric welding a high frequency electrical supply is provided to the electrodes. The supply may in principle be at a frequency between 1 MHz and 200 MHz, usually between 10 MHz and 100 MHz, but stringent limits are imposed on any emitted radio waves. In practice therefore the choice of frequency may be more limited. For example the supply frequency may be 27.12 MHz, or 40.68 MHz. Preferably one electrode is connected to a generator and the other electrode is earthed. Preferably a matching network is connected between the generator and the electrode.

In a further aspect, the invention provides a sachet formed by the method of the invention, the sachet containing a food material.

The invention will now be further and more particularly described, by way of example only, and with reference to the accompanying drawing in which:

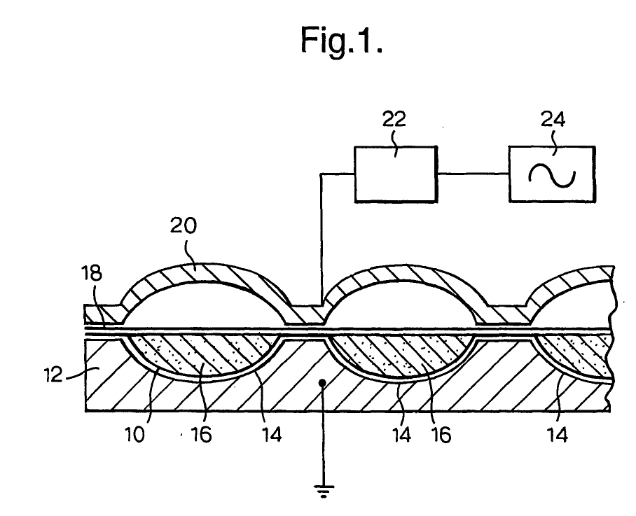

FIG. 1 shows a diagrammatic sectional view of an apparatus for making soup sachets.

### EXAMPLE 1

Films of starch containing a plasticiser and of thickness 50 μm are used to produce dried soup sachets which can be mixed with hot water to form soup. The sachets are formed by a flat bed process, in which a first sheet 10 of the film is laid on a flat tray 12 in which are forty-eight recesses 14 which acts as moulds. The moulds 14 are evacuated to pull the film 10 into them. Appropriate quantities of dried soup mix 16 are then dispensed into each recess in the film 10. A cover film 18 is then laid across the tray 12.

The tray 12 may then be moved to a second location, at which an upper tray 20 with a matching set of recesses is placed on top of the tray 12, and pressure is applied between them. The upper tray 20 is connected via a matching network 22 to a solid-state radio-frequency generator 24, while the lower tray 12 is connected to earth, preferably to the earth of the matching network 22. The matching network 22 incorporates variable capacitors and servomotors operated such that the impedance presented to the generator 24 remains at a constant value such as 50 Ω. This ensures that, despite changes in the load, excessive voltages are not applied between the electrodes (i.e. the lower tray 12 and the upper tray 20).

The regions of the films 10 and 18 around each recess 14 are hence subjected to dielectric heating and pressure, and the polymeric starch material melts at the interface between the two films 10 and 18. After welding has been performed, the upper tray 20 is removed, and the films 10 and 18 (now bonded together and defining forty-eight sachets) are removed from the lower tray 12. The bonded films around each sachet and then cut to remove the sachets, each with a projecting flange of bonded films.

Such a sachet can simply be dropped into a cup of boiling hot water, and stirred to form soup. The films 10 and 18 are of thickness selected to provide rapid dissolution, although with sufficient strength to be handled. Even where the films are bonded together, they still undergo rapid dissolution.

### EXAMPLE 2

A film 35 μm thick of thermoplastic starch is formed into a tube 14 cm in diameter by welding opposite edges of a strip together using opposed straight electrodes in a similar manner to that described in relation to the previous example. The tube is held upright, and the bottom is sealed using RF welding between two straight electrodes. A predetermined quantity (e.g. 750 g) of a bread mix is dispensed into the bottom of the tube, and the tube is then sealed above this bread mix. This seal may be performed using two straight electrodes of width 6 mm. The resulting sachet containing bread mix is then cut off from the tube, cutting half way through the seal so as to produce a 3 mm wide flange of bonded film.

The remaining half of the seal now forms the bottom of the tube, and the predetermined quantity of the bread mix is again dispensed into the bottom of the tube, and the tube again sealed above the bread mix, and the resulting sachet cut off. This process is repeated until the complete length of tube has been used up.

In the domestic context, one such sachet can be mixed with water, and baked (if it is a non-yeast mixture) or left to prove, kneaded, left to prove and then baked (if it is a yeast mixture). There is evidently no need to open the sachet, as the sachet will dissolve in the water.

### EXAMPLE 3

Individual servings of coffee powder are packaged into small sachets formed between rotary dies in which are opposed recesses. Two strips of film, each of thickness 20 μm, are fed between the dies, and the coffee powder is introduced into the sachets as they are formed between the dies. The films are bonded in an analogous way to that described in the previous examples: radio-frequency signals are applied between the two dies, and the signals may be coupled using capacitive couplings to the dies. The individual sachets are then cut out, leaving a projecting flange of bonded films around each sachet.

All three of these examples are situations in which the material that is being packed is likely to leave dusty or powdery deposits on the surfaces of the films to be bonded. Nevertheless good quality bonds are formed despite the presence of any such dusty deposit.

1. A process for making sachets, the process using at least one thin and flexible film of a water-soluble and edible polymeric material, the film or films being shaped to define a sachet and filled with a food material, and being sealed to form a flange seal by RF welding between opposed electrodes.

2. A process for making sachets, the process using at least one thin and flexible film comprising starch, the film or films being shaped to define a sachet, and being sealed to form a flange seal by RF welding between opposed electrodes.

3. A process for making sachets as claimed in claim 1 wherein the film is no more than 50 μm thick.

4. A process for making sachets as claimed in claim 1 wherein the RF welding uses a solid state RF signal generator and a matching network.

5. Sachets made by a method as claimed in claim 1 containing food material which is intended to be added to water, before being eaten or drunk.

6. Sachets as claimed in claim 5 wherein the food material is intended to be added to hot water.

7. Sachets made by a method as claimed in claim 1 wherein the food material is one which is intended to be added to water before being cooked.

8. Sachets as claimed in claim 5 for domestic use.

9. A process for making sachets as claimed in claim 2 wherein the film is no more than 50 μm thick.

10. A process for making sachets as claimed in claim 2 wherein the RF welding uses a solid state RF signal generator and a matching network.

11. Sachets made by a method as claimed in claim 2 containing food material which is intended to be added to water, before being eaten or drunk.

12. Sachets made by a method as claimed in claim 2 wherein the food material is one which is intended to be added to water before being cooked.
